(19) United States
(12) Patent Application Publication
(10) Pub. No.: US 2004/0239188 A1
(43) Pub. Date: Dec. 2, 2004

(54) Power supply load balancing apparatus

(75) Inventors: Robert H. Bohl, Ft. Collins, CO (US); Duane L. Harmon, Loveland, CO (US); Kelly J. Reasoner, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX

(21) Appl. No.: 10/447,449

(22) Filed: May 28, 2003

(51) Int. Cl. H02J 1/10; H02J 3/46

(52) U.S. Cl. 307/24

(57) ABSTRACT

A power supply load balancing apparatus comprises a voltage converter capable of accepting a plurality of supply voltages and converting a selected supply voltage selected from among the plurality of supply voltages to an output voltage, and a controlled rate switch. The controlled rate switch is coupled to the voltage converter and capable of selecting from among the plurality of supply voltages. The controlled rate switch applies switching among the plurality of supply voltages at different rates to unambiguously apply the selected supply voltage to the voltage converter.

### BACKGROUND OF THE INVENTION

Organizations that rely on information technology are acutely aware that system downtime leads to lost customers, lost profit, and a soiled reputation. System availability defines the reliability of on-line enterprise to service customers and fulfill business promises.

One aspect of availability is scalability. As the number of applications and network participants increases, the amount of information that passes through servers expands. System capacity must increase steadily as demand increases. Availability relates to scalability since failures can be caused by lack of capacity as well as component failure. Available systems must also respond to changing loads and circumstances without a reduction in response.

An available system reduces both unplanned downtime due to system failure or disruption, and planned downtime. Available systems are designed to rapidly survive failures by repair, upgrade, or expansion, rapidly and without reducing services.

Scalability is often attained by modular design, for example using cabinets with multiple component slots that can be installed with additional components and devices, as needs increase. Alternatively, modular systems may increase capacity by facilitating connectivity among multiple separate functional units.

In some circumstances or conditions, scalability is limited by the power supply capacity of a system. A modular system that accepts multiple functional modules can exceed the power supply capability with the addition of modules. In one scenario, a legacy system may have insufficient power capacity to supply later-generation system designs or functional modules. In another circumstance, a modular system may flexibly accept modules of different models, possibly from many different manufacturers, so that power ratings may be exceeded.

Commonly available systems are designed with redundant elements to avoid system failure. However, availability can remain limited by the power supply capacity of a system. Failure of a power supply in a redundant system creates a condition of insufficient capacity for installed functional modules.

### SUMMARY OF THE INVENTION

In accordance with some embodiments of the disclosed system, a power supply load balancing apparatus comprises a voltage converter capable of accepting a plurality of supply voltages and converting a selected supply voltage selected from among the plurality of supply voltages to an output voltage, and a controlled rate switch. The controlled rate switch is coupled to the voltage converter and capable of selecting from among the plurality of supply voltages. The controlled rate switch applies switching among the plurality of supply voltages at different rates to unambiguously apply the selected supply voltage to the voltage converter.

In accordance with other embodiments, a modular system comprises an enclosure with a plurality of slots capable of accepting a respective plurality of functional modules, a power supply capable of supplying a plurality of supply voltages, and a power supply load balancer coupled between the power supply and a slot of the plurality of slots. The power supply load balancer is capable of unambiguously selecting a supply voltage from among the plurality of supply voltages and converting the selected supply voltage to an operational voltage.

In accordance with further embodiments, a method of sharing output load comprises supplying voltages from a plurality of sources to a slot in a modular system including a plurality of slots, selectively switching on and off at least one of the plurality of sources, and applying the selective switching among the plurality of sources at different rates to unambiguously supply voltage from the selected source.

### BRIEF DESCRIPTION OF THE DRAWINGS

Embodiments of the invention relating to both structure and method of operation, may best be understood by referring to the following description and accompanying drawings.

FIG. 1 is a schematic circuit diagram that illustrates an embodiment of a circuit capable of power supply load balancing.

FIG. 2 is a schematic circuit diagram showing an alternative embodiment of a circuit capable of power supply load balancing.

FIG. 3 is a pictorial block diagram showing an embodiment of a modular system that can accept a plurality of functional modules.

FIG. 4 is a schematic block diagram showing an example of a suitable storage device for implementing an embodiment of a power supply load balancing apparatus.

FIG. 5 is a schematic three-dimensional pictorial diagram showing an example of a storage module in a library that includes a suitable bridge module for implementing power supply load balancing.

FIG. 6 is a schematic block diagram that depicts connections of multiple bridge modules with power supply load balancing in an embodiment of a multiple storage module library.

### DETAILED DESCRIPTION

What is desired is an apparatus and associated operating technique for power supply load balancing in a modular system. What is further desired is a system that can exploit the power capacity of a modular system to meet power needs of components and devices in the system even when loaded near or to capacity, and in conditions of power supply failure.

Embodiments of a power supply load balancer enable output load sharing in a multiple output power supply configuration. A power supply load balancer can be implemented in the input power supply line of individual modules in a system or enclosure that can accept multiple modules. A power supply load balancer enables a module to draw power from any of multiple output power supply lines.

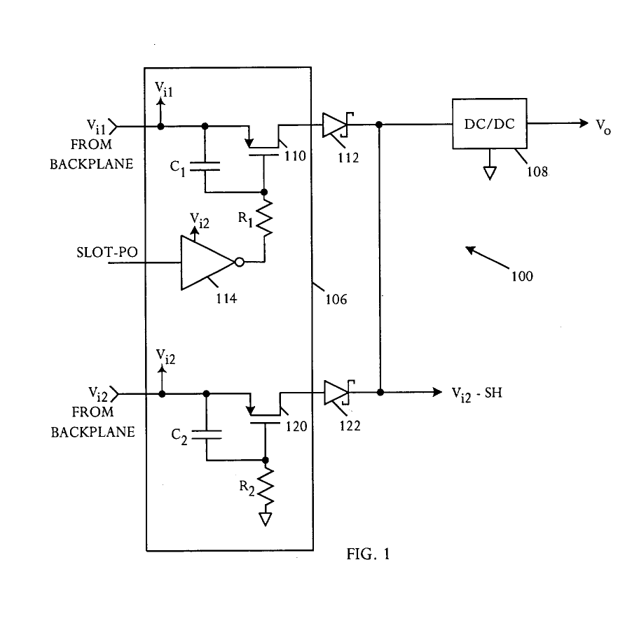

Referring to FIG. 1, a schematic circuit diagram illustrates an embodiment of circuit 100 capable of power supply load balancing. The power supply load balancer 100 performs output load sharing in a multiple output power supply configuration. In the illustrative example, a system has two supply voltages Vᵢ₁ and Vᵢ₂ on a backplane and generates an output voltage V₀ that is operational for powering an individual module in a modular system that can combine multiple modules. In other embodiments, additional power supply voltages may be available and a circuit may balance loads for the additional voltages.

The power supply load balancer 100 comprises a voltage converter, for example a DC/DC converter 108, that can accept either voltage Vᵢ₁ or Vᵢ₂, and generate from the input voltage an output voltage of V₀. The DC/DC converter 108 is connected to pathways connected to the backplane supply lines Vᵢ₁ and Vᵢ₂. The pathways include Schottky diodes that function as an isolator to isolate the input voltages Vᵢ₁ and Vᵢ₂, and field effect transistors (FETs) that manage switching of the power sources Vᵢ₁ and Vᵢ₂. For example, the Vᵢ₁ pathway includes FET 110 and Schottky diode 112. An R/C circuit including capacitor C₁ and resistor R₁ adjusts FET 110. Vᵢ₂ pathway includes FET 120 and Schottky diode 122 and passes a shared voltage Vᵢ₂-SH that can be shared with other devices and components. An RIC circuit including capacitor C₂ and resistor R₂ adjusts FET 120. In other embodiments, other types of isolating devices, such as other types of diodes, may be used.

The power supply load balancer 100 can be the power interface for a module for installation in a system that accepts multiple modules to enable output load sharing for the multiple output (Vᵢ₁ and Vᵢ₂) power supply configuration. The power supply load balancer 100 is useful when multiple modules with a voltage requirement of V₀ in combination exceed the power supply capabilities of the Vᵢ₁ and Vᵢ₂ power supplies alone. The power supply load balancer 100 enables the module to draw power from either supply Vᵢ₁ or Vᵢ₂. The DC/DC converter 108 can accept either Vᵢ₁ or Vᵢ₂. The Vᵢ₁ and Vᵢ₂ power supplies are connected to the DC/DC converter 108 through Schottky diode 112 and Schottky diode 122, respectively, to mutually isolate the Vᵢ₁ supply from the Vᵢ₁ supply. Schottky diodes efficiently isolate the different supplies although other types of isolation may be used.

The FET 110 and associated R₁ C₁ circuit, and FET 120 and associated R₂ C₂ circuit, operate in conjunction to form a soft switch 106 that generates a soft start behavior and controls application of the Vᵢ₁ and Vᵢ₂ to the DC/DC converter 108 with different time constants. A backplane pin SLOT_PO passed through a gate such as inverter 114 selects the power supply voltage Vᵢ₁ or Vᵢ₂ passed by DC/DC converter 108. The backplane pin connection SLOT_PO through gate inverter 114 enables switching on and off of the Vᵢ₁ supply. In the illustrative embodiment, the voltage Vᵢ₁ is larger that voltage Vᵢ₂. Also in the illustrative embodiment, the Vᵢ₂ supply line does not use a switch function since the Vᵢ₁ supply overrides the Vᵢ₂ supply when Vᵢ₁ is enabled. In the illustrative embodiment, the enabler for the Vᵢ₁ supply is the backplane pin SLOT_PO that alternates high and low for adjacent slots in a card cage. Accordingly, the modules in adjacent slots alternate between the Vᵢ₁ and Vᵢ₂ supplies as the card cage is filled sequentially. In other embodiments, other selection criteria may be used.

The soft start behavior is useful to enable one supply, for example Vᵢ₁, to begin operating more quickly than the second supply, here Vᵢ₂, to unambiguously select the voltage supply, eliminating the possibility that all modules could simultaneously attempt to draw from the same supply, here Vᵢ₂, causing overloading.

In a specific implementation, the power supply load balancer 100 can be used in a storage device such as a tape or disk library. The power supply load balancer 100 can be implemented on individual fibre bridge modules in a system that can accept multiple bridges. The power supply in the storage device can supply 5V at 25 A and 12V at 8 A. The primary voltage requirement of the individual modules is 3.3V at 5 A so that capacity usage of the system exceeds the power capability of either the 5V or the 12V supply alone.

The illustrative DC/DC converter 108 accepts either 5V or 12V and generates 3.3V. Schottky diodes 112 and 122 mutually isolate the 5V and 12V supplies. The FET and RC circuits generate the soft start behavior and the capability to switch the 12V supply. The soft start capability enables the 12V supply to activate faster than the 5V supply, so that all modules do not attempt to simultaneously draw from and overload the 5V supply.

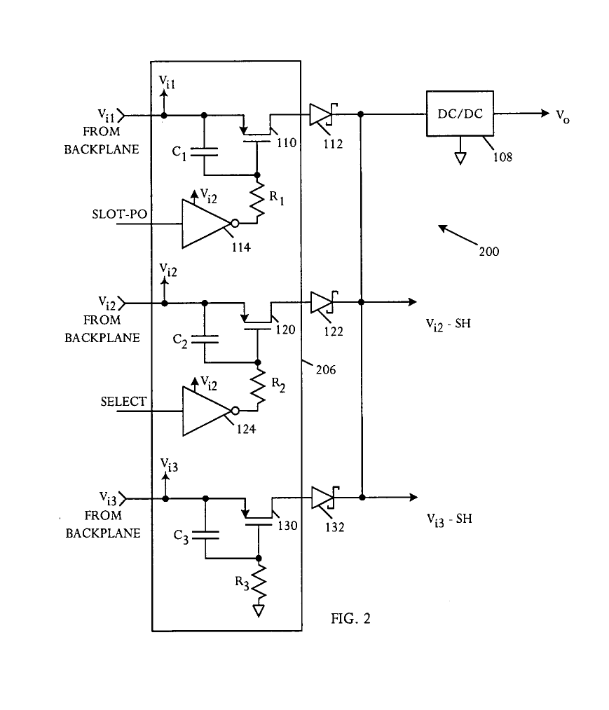

Referring to FIG. 2, a schematic circuit diagram shows an alternative embodiment of a circuit capable of power supply load balancing 200. The circuit 200 can select from among an additional power supply Vᵢ₃ and includes a power line filter, soft switch 206, and isolation for the additional supply line. FET 130, resistance R₃, and capacitance C₃ supply filtering and switching for the additional line. Schottky diode 132 supplies isolation to the supply Vᵢ₃. A select signal SELECT that can be any suitable signal for activating a particular supply is passed through gate inverter 124 and enables switching on and off of the Vᵢ₂ supply. In the illustrative embodiment, the voltage Vᵢ₁ is larger that voltage Vᵢ₂, which, in turn is larger that voltage Vᵢ₃.

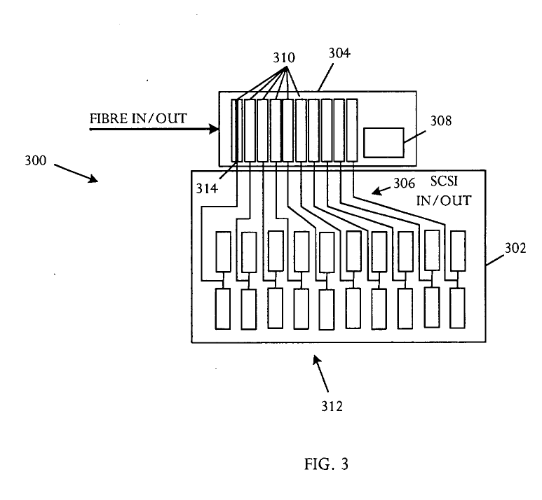

Referring to FIG. 3, a pictorial block diagram shows an embodiment of a modular system 300 that comprises an enclosure 302 with a plurality of slots 310 capable of accepting a plurality of functional modules 314. The functional modules 314 can include a power supply load balancer such as the balancers described in FIGS. 1 and 2. The power supply load balancers are capable of selecting a supply voltage from among a plurality of supply voltages and converting the selected supply voltage to an operational voltage. The modular system 300 further comprises a power supply 308 capable of supplying two or more supply voltages.

The modular system 300 can also have a card cage 304 coupled to the enclosure 302 that forms the structure for holding the plurality of slots 310, and a backplane 306 that supplies power and signal lines. The signal lines can include a signal for controlling activation or deactivation of one or more of the voltage supply sources.

In some embodiments, only one supply is switched and the other supplies are intrinsically enabled or disabled accordingly. In other embodiments, switches can control some or all supply lines. 100301 In some embodiments, the modular system 300 can be a storage system such as a storage library. In one example, the card cage 304 can supply slots for a plurality of similar or identical functional modules that perform the same function. In a specific example, the card cage 304 supplies storage for a plurality of fibre bridges that convert fibre channel to Small Systems Computer Interface (SCSI) protocol. The fibre bridges connect one server or host to a plurality of storage drives 312 such as tape or disk drives.

In the particular example, the power supply 308 can supply two voltages, such as 5V and 12V. In some systems, the 5V supply can power electronic functional modules, and the 12V supply is generally furnished to power electromechanical components such as robotic systems for moving media to the drives. The illustrative power supply load balancer can exploit availability of the 12V supply to ensure sufficient power capabilities for supporting capacity or near-capacity functional module configurations.

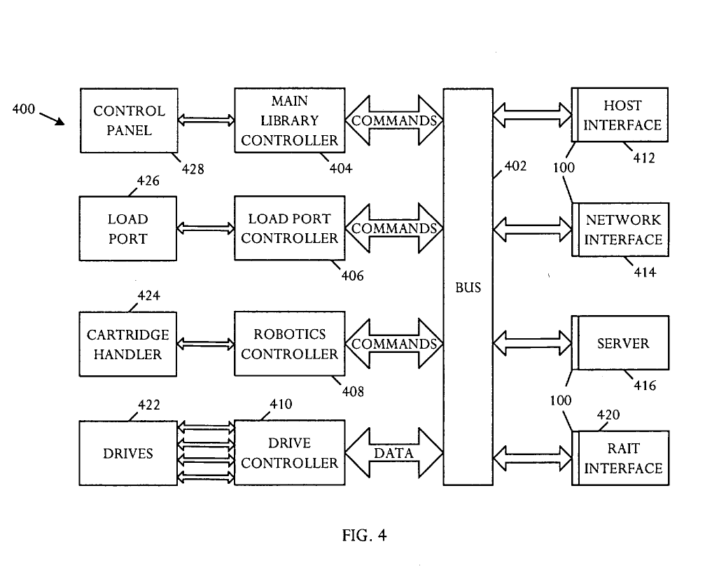

Referring to FIG. 4, a schematic block diagram shows an example of a suitable storage device 400 that can implement embodiments of power supply load balancing. The storage device 400 can be any type of storage device such as a drive or library. Some storage devices 400 can be tape drives or tape libraries, others can be disk drives or other storage drives, for example optical storage drives.

The storage device 400 incorporates a bus backplane such as a Peripheral Component Interconnect (PCI) bus backplane to interface with multiple various types of devices, systems, or components. For example, the storage device 400 includes a bus 402 with connections to a plurality of slots that can accommodate multiple types of functional modules. The functional modules can include a load balancer such as the circuits shown in FIGS. 1 and 2. In an illustrative example, the functional modules with a power supply load balancer 100 may include a host interface 412, a network interface 414, a server 416, and a Redundant Array of Inexpensive Tapes (RAIT) interface 420. The host interface 412 can support connectivity to various links including SCSI, Ultra-SCSI, Ultra-2 SCSI, Gigabit Ethernet, Fibre Channel, and others, enabling connection directly to Fibre Channel backup servers and networks with additional fibre channel adapter cards. The network interface 414 can directly connect to networks with the addition of PC-Ethernet, Peripheral Component Interconnect-Fiber Distributed Data Interface (PCI-FDDI) and Peripheral Component Interconnect-Asynchronous Transfer Mode (PCI-ATM) cards. The server 416 interface can accommodate single card processors or CPUs or be used as a network-attached storage device. The RAIT interface 420 enables support of fault tolerance through auto tape copy, mirroring, and tape stripping with parity by adding tape RAIT cards.

The storage device 400 has multiple controllers that control and manage various electrical or electromechanical components. In some systems, electro-mechanical components may be configured to utilize a power source, for example a 12V supply, that differs from the power supply to other electronics modules in general, for example a 5V supply. The illustrative system utilizes load balancing that exploits availability of the 12V supply to facilitate scalability, availability, and reliability of a modular storage system.

The controllers can include a main library controller 404, a load port controller 406, a robotics controller 408, and a drive controller 410. The main library controller 404 is a system controller that performs multiple various control, management, and monitoring operations including multiple-host and library partitioning, serial communications control, diagnostics, and data pass-through. For example, the main library controller 404 supports system administration via connection to a control panel 428 such as a graphical user interface (GUI) touch screen for facilitating operational functionality, configuration, fault determination, and diagnostic testing.

The drive controller 410 communicates with multiple storage drives 422 and controls multiple operations including data routing, drive utilization, and drive failover. In one example, the storage device 400 can be a tape library that includes a dozen or more tape drives and slots for hundreds of tape cartridges.

The load port controller 406 communicates with a load port 426 and manages entry and exit of data cartridges into the storage device 400. In one example, the load port 426 can include one or more multiple cartridge removable magazines to facilitate cartridge import and export and off-site data storage.

The robotics controller 408 communicates with robotics such as a cartridge handling mechanism 424 that carries data cartridges between storage slots, the storage drives 422, and the load port 426.

Commands received from the various interfaces, the host interface 404, network interface 406, server 408, and RAIT interface 410 can control operations of at least the storage drives 422 and the robotics 424.

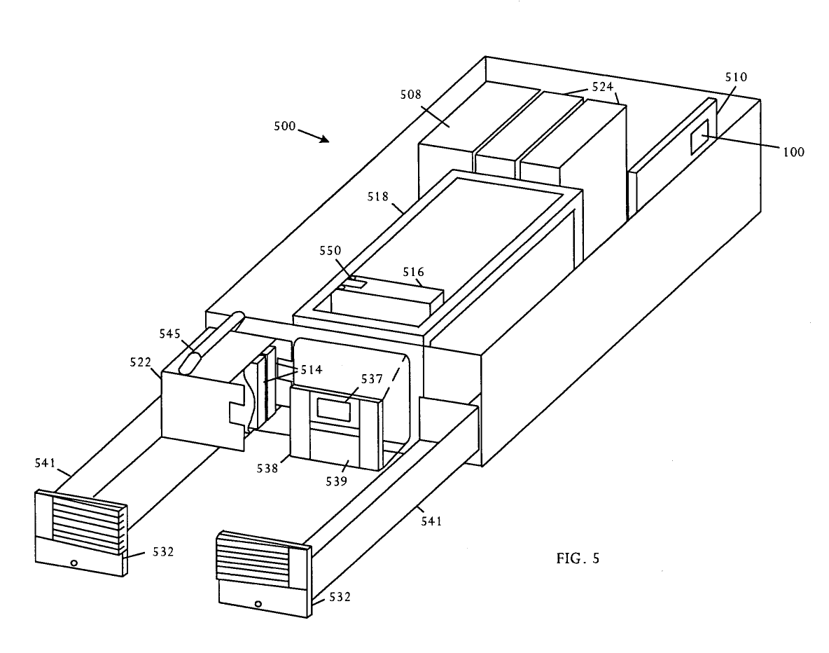

Referring to FIG. 5, a schematic pictorial diagram shows an example of a media storage module 500 that includes one or more fibre bridges 510, one or more power supplies 508, and can include a plurality of storage drives 524. The fibre bridges 510 can be modules that implement a power supply load balancer 100 using a circuit such as those shown in FIGS. 1 and 2. The storage drives 524 can be any suitable storage read/write devices such as tape drives, disk drives, or drives for other storage types. The media storage module 500 can include one or more of which can be used in a media storage library system to store and retrieve data cartridges 514 and to read and write data onto to data cartridges 514.

The illustrative media storage module 500 comprises a cartridge engaging assembly 516 that is sometimes termed a robotic carrier that is moveably mounted to a guide frame 518 contained within the media storage module 500. The media storage module 500 also comprises one or more storage drives 524 that can perform read and write access of a data cartridge 514. The data cartridges 514 may be contained within one or more different types of cartridge receiving devices such as one or more cartridge magazines 522 and one or more storage drives 524. The transport assembly 550 engages cartridge changing assembly 516 to move data cartridges 514 within media storage module 500.

In some systems, cartridge engaging assembly 516, transport assembly 550, and other electromechanical components may be configured to utilize a power source, for example a 12V supply, that differs from the power supply to other electronics modules in general, for example a 5V supply. The illustrative system utilizes load balancing that exploits availability of the 12V supply to facilitate scalability, availability, and reliability of a modular storage system.

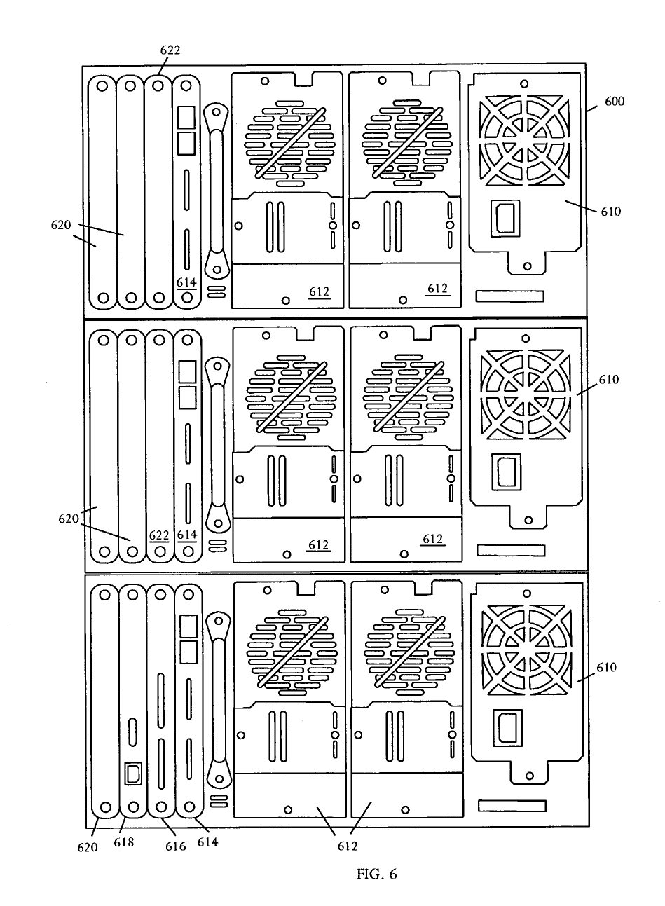

Referring to FIG. 6, a schematic pictorial diagram depicts an embodiment of a suitable storage system 600 that can utilize power supply load balancing. The illustrative embodiment shows a modular system that can include multiple modular levels with each level having a plurality of slots for accepting functional modules. In the illustrative storage system 600, each level has a power supply 610 and has capacity for two drives 612 such as tape drives or disk drives. Each power supply 610 generates a plurality of supply voltages. Each level has a plurality of slots that can accept functional modules including fibre bridges 614, controllers 616, remote management cards 618, server controllers 622, and the like. The scalable system may have vacant slots 620. In some embodiments, the fibre bridges 614 include load balancing capabilities.

Many variations, modifications, additions and improvements of the embodiments described are possible. For example, although Schottky diodes are disclosed for usage in isolating the power sources, other isolating devices and circuits may be used. Although the controlled rate switch are described as FETs with associated RC circuits, other transistors or other types of filtering elements may be used. Although the illustrative embodiment shows a control signal applied to only one supply line, other embodiments may apply control signals to multiple lines. In some embodiments, the various types of functional modules can include a power supply load balancing circuit to balance loads among a plurality of functional modules of different types.

What is claimed is:

1. A power supply load balancing apparatus comprising:
a voltage converter capable of accepting a plurality of supply voltages and converting a selected supply voltage selected from among the plurality of supply voltages to an output voltage; and
a controlled rate switch coupled to the voltage converter and capable of selecting from among the plurality of supply voltages, the controlled rate switch applying switching among the plurality of supply voltages at different rates to unambiguously apply the selected supply voltage to the voltage converter.

2. The power supply load balancing apparatus according to claim 1 further comprising:
a first transistor coupled between a first supply voltage source and the voltage converter, the first transistor having a control terminal coupled to a control line through a first resistor/capacitor (RC) circuit that determines a first time constant; and
a second transistor coupled between a second supply voltage source and the voltage converter, the second transistor having a control terminal coupled to ground through a second resistor/capacitor (RC) circuit that determines a second time constant that is slower than the first time constant.

3. The power supply load balancing apparatus according to claim 3 further comprising:
a third transistor coupled between a first supply voltage source and the voltage converter, the third transistor having a control terminal coupled to a control line through a third resistor/capacitor (RC) circuit that determines a third time constant that is different from the first and second time constants.

4. The power supply load balancing apparatus according to claim 1 wherein the voltage controller is a direct current-to-direct current (DC/DC) voltage controller.

5. The power supply load balancing apparatus according to claim 1 further comprising:
an isolator coupled to the voltage converter and the controlled rate switch that mutually isolates the plurality of supply voltages.

6. The power supply load balancing apparatus according to claim 5 wherein the isolator comprises a plurality of Schottky diodes respectively coupled between a plurality of supply voltage sources and the voltage converter.

7. The power supply load balancing apparatus according to claim 1 wherein a first supply voltage is 12V, a second supply voltage is 5V, and the output voltage is 3.3V.

8. A modular system comprising:
an enclosure with a plurality of slots capable of accepting a respective plurality of functional modules;
a power supply capable of supplying a plurality of supply voltages; and
a power supply load balancer coupled between the power supply and a slot of the plurality of slots, the power supply load balancer capable of unambiguously selecting a supply voltage from among the plurality of supply voltages and converting the selected supply voltage to an operational voltage.

9. The modular system according to claim 8 further comprising:
at least two power supply load balancers coupled between the power supply and respective at least two slots of the plurality of slots; and
a connection coupled to selected power supply load balancers of the at least two power supply load balancers and supplying an enable signal so that power is alternatively supplied from among the plurality of power supply voltages to slots coupled to the selected and unselected power supply load balancers.

10. The modular system according to claim 8 further comprising:
a plurality of power supply load balancers coupled respectively to the plurality of slots; and
at least one connection coupled to the power supply load balancers coupled to alternating slots of the plurality of slots and supplying at least one enable signal so that power is supplied from alternating power supply voltages.

11. The modular system according to claim 8 wherein:
the power supply load balancer further comprises a controlled rate switch capable of selecting from among the plurality of supply voltages, the controlled rate switch applying switching among the plurality of supply voltages at different rates to unambiguously apply the selected supply voltage to the voltage converter.

12. The modular system according to claim 8 wherein the modular system is a storage system and a power supply load balancer is implemented in a bridge functional module in a storage system that accommodates a plurality of bridge functional modules.

13. The modular system according to claim 8 wherein the modular system is a storage system and the plurality of functional modules can have a plurality of function types.

14. The modular system according to claim 8 further comprising:
a backplane supplying a plurality of power and signal lines, the signal lines including an enable signal line for a first supply voltage that alternates high and low for adjacent slots so that selected supply voltages alternate among the plurality of slots in sequence.

15. The modular system according to claim 8 wherein one supply voltage of the plurality of supply voltages is predominantly used to supply electronic functional modules and another supply voltage is predominantly used to supply electromechanical components.

16. A method of sharing output load comprising:
supplying voltages from a plurality of sources to a slot in a modular system including a plurality of slots;
selectively switching on and off at least one of the plurality of sources; and
applying the selective switching among the plurality of sources at different rates to unambiguously supply voltage from the selected source.

17. The method according to claim 16 further comprising:
converting the supplied voltage to a voltage operational in the module.

18. The method according to claim 16 further comprising:
mutually isolating the plurality of sources.

19. A method according to claim 16 further comprising:
separately filtering the supplied voltage from the plurality of voltage sources so that the different voltage sources switched with different time constants.

20. A method according to claim 16 further comprising:
applying an enable signal to less than all of the voltage sources.

21. A method according to claim 20 further comprising:
separately filtering the supplied voltage from the plurality of voltage sources so that the different voltage sources are switched with different time constants wherein the switched voltage source overrides the unswitched voltage sources when the switched source is enabled.

22. A load balancing apparatus comprising:
means for supplying voltages from a plurality of sources to a slot in a modular system including a plurality of slots;
means for selectively switching on and off at least one of the plurality of sources; and
means for applying the selective switching among the plurality of sources at different rates to unambiguously supply voltage from the selected source.

23. The apparatus according to claim 22 further comprising:
means for converting the supplied voltage to a voltage operational in the module.

24. The apparatus according to claim 22 further comprising:
means for mutually isolating the plurality of sources.

25. The apparatus according to claim 22 further comprising:
means for holding a plurality of functional modules; and
means for supplying power and data signals to the plurality of functional modules.
